(19) United States
(12) Patent Application Publication
(10) Pub. No.: US 2010/0310138 A1
(43) Pub. Date: Dec. 9, 2010

(54) FINDING PAIRED ISOTOPE GROUPS

(76) Inventors: Andrey Bondarenko, Bellevue, WA (US); Alexander Spiridonov, Redmond, WA (US); Lee Weng, Bellevue, WA (US)

Correspondence Address: KLARQUIST SPARKMAN LLP, 121 S.W. SALMON STREET, SUITE 1600, PORTLAND, OR, 97204, US

(21) Appl. No.: 12/663,168

(22) PCT Filed: Jun. 4, 2008
(86) PCT No.: PCT/US08/65820

§ 371 Date: Aug. 4, 2010

Related U.S. Application Data
(60) Provisional application No. 60/941,935, filed on Jun. 4, 2007.

(51) Int. Cl. G06K 9/62

(52) U.S. Cl. 382/128

(57) ABSTRACT

A technique for finding paired isotope groups of peptides, metabolic materials, or other materials is executed without having to identify features. Any suitable isotopic labeling methods, such as SILAC or ICAT, can be used. The technique can identify isotope pairs by pairing heavy and light labeled peptides based on mono-isotopes. The technique searches for isotope groups that have retention time and mass/charge within given tolerances, adjustable by users. Multiple label sites are supported as well as reverse-labeling to inhibit or reduce biases. Multiple replicates can be merged into a composite image.

### BACKGROUND

Isotopic labeling is one of two techniques for using isotopes to observe biological samples, at various molecular or atomic levels. One technique uses radioactive isotopes. The other technique involves less abundant, non-radioactive, or stable, isotopes. Observations are made by measuring the relative abundance of stable isotopes using equipment, such as mass spectrometers, which are devices that determine the relative amounts of various stable isotopes in a biological sample being analyzed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with this invention, a method, a computer-readable medium, and a system are provided. One method form of the invention includes a method for finding paired features in biological samples. The method comprises forming a composite image from an experiment in which a control sample and a treated sample, which has a tracing relationship with the control sample, are brought together as a prepared sample without having to identify a nucleic acid sequence of features. The method further comprises finding pairs of features of interest from the composite image, a member of a pair of features of interest being associated with another member of the pair according to the tracing relationship, which describes a constraint to find both members of the pair on the composite image.

In accordance with another aspect of the invention, a computer-readable medium form of the invention includes a computer-readable medium having computer-executable instructions stored thereon for implementing a method for finding paired features in biological samples. The method comprises forming a composite image from an experiment in which a control sample and a treated sample, which has a tracing relationship with the control sample, are brought together as a prepared sample, without having to identify a nucleic acid sequence of features. The method further comprises finding pairs of features of interest from the composite image, a member of a pair of features of interest being associated with another member of the pair according to the tracing relationship, which describes a constraint to find both members of the pair on the composite image.

In accordance with another aspect of the invention, a system form of the invention includes a system for finding paired features of interest. The system comprises a collection of chromatography and mass spectrometry instruments for receiving a prepared sample in which a control sample and a treated sample are submitted together for processing. The system further comprises an image processing pipeline for creating and processing a composite image from the prepared sample on which features are extracted and characteristics are calculated. The system further comprises a paired feature processor for processing the features from the composite image to find pairs of features of interest that are associated with one another according to a relationship without having to first identify the nucleic acid sequences of the features.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary system for finding paired features of biological samples that have a relationship that defines their pairing;

FIG. 2 is a block diagram illustrating an exemplary paired feature processor for finding paired features of biological samples that have a relationship that defines their pairing;

FIG. 3 is a pictorial diagram illustrating an exemplary graph of isotope groups separated by labels with the x axis representing retention time and the y axis representing mass over charge;

FIGS. 4A-4C are pictorial diagrams illustrating exemplary graphs that show bias connected with isotopic labeling and its elimination or reduction according to various embodiments of the present invention; and

FIGS. 5A-5K are process diagrams illustrating an exemplary method for finding paired features of interest in biological samples according to a relationship.

### DETAILED DESCRIPTION

As will be illuminated, various embodiments of the present invention recognize the problem of identifying features, such as determining the exact protein sequences, before discovering pairs of features that are associated due to an experimental or biological relationship. Also, various embodiments of the present invention use a composite image formed from multiple samples being submitted to LC/MS instruments as a prepared sample or from multiple replicates so as to better reduce noise and better detection of features that have weak expression. Furthermore, various embodiments of the present invention allow isotopic labeling to be reversed to inhibit or reduce biases connected with isotopic labeling processes.

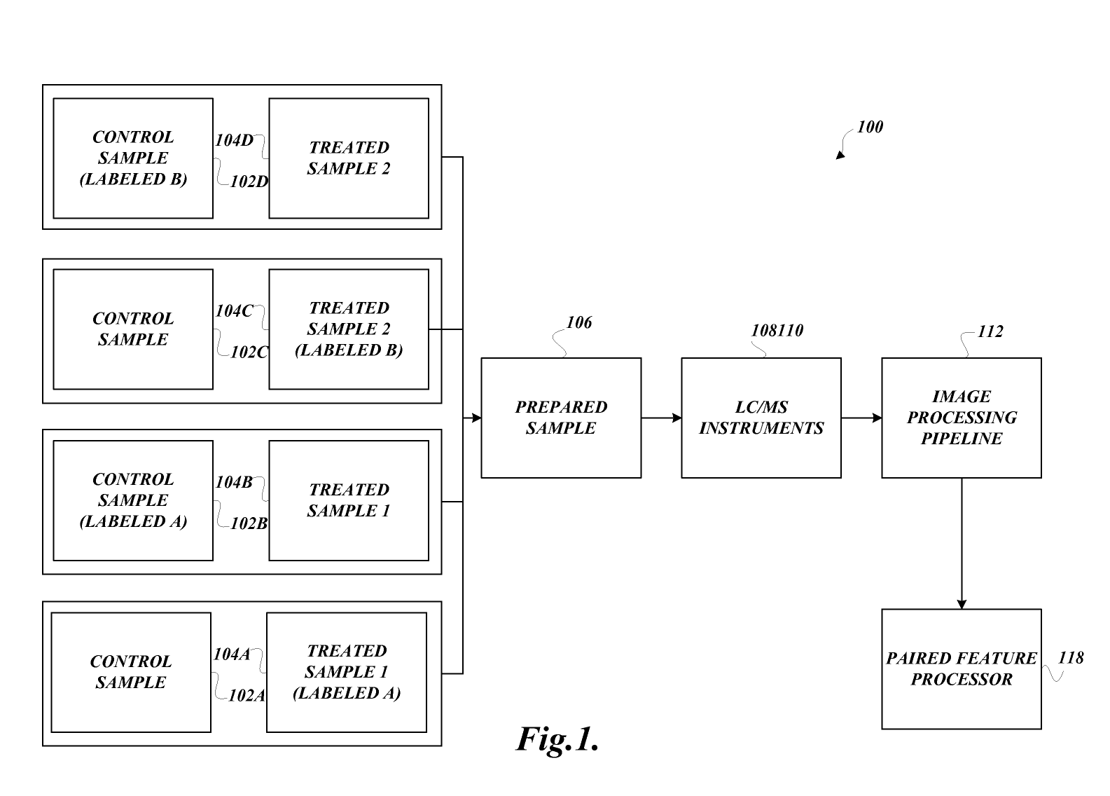

A system 100 in which paired features of interest are discovered from biological samples is shown in FIG. 1. Generally, experiments can be reduced to a comparison between two things: that which is a control and that which is treated; that which is not diseased and that which is diseased; that which is well and that which is sick; and so on. In proteomic experiments, scientists desire to know whether proteins behave differently with respect to introduced conditions. In metabolic experiments, scientists desire to know whether metabolites behave differently with respect to introduced conditions. There are many other types of experiments that can suitably leverage various embodiments of the present invention to better understand drug treatments, therapeutic outcomes, and toxicity risks.

Various embodiments of the present invention allow paired features of biological samples to be found without at first having to identify the features. After pairing, various embodiments allow the features, be they differentially or non-differentially expressed, to proceed to targeted identifications. Those features, now paired, if not having been previously identified, can be sent to tandem mass spectrometry or other pieces of equipment for identification of the peptide (or protein) sequences or metabolites. After the peptide, protein, or metabolite identification (or other biological identification), these features may be annotated by the peptide, sequence, protein sequence or metabolite information (or other biological information).

Returning to FIG. 1, a control sample 102A is set aside. A treated sample 1 104A is an instance of the control sample that has undergone a treatment condition. Furthermore, added to or recognized within the treated sample 1 104A is a trace that allows its relationship to the control sample 102A to be tracked. One suitable trace is the addition of a label using a suitable isotopic labeling technique, such as SILAC or ICAT. A selected number of atomic mass units, such as six daltons, is used to label the treated sample 1 104A. This selected number or label will be used later in the system 100 to trace the relationship of the control sample 102A and the treated sample 1 104A when they are represented as pairs of features found on a composite image. One member of the paired features probably originates from the control sample 102A and the other member of the paired features probably originates from the treated sample 1 104A. As illustrated in FIG. 1, the label that is used to label the treated sample 1 104A has a nomenclature of “labeled A.”

The control sample 102A and the treated sample 1 104A (labeled A) can be prepared as a prepared sample 106 to be submitted as a single run to the system 100. By allowing both the control sample 102A and the treated sample 1 104A (labeled A) to come into the system 100 as one prepared sample 106, various embodiments of the present invention inhibit or reduce equipment dependent variations, which can inject falsities into experiments. With equipment dependent variations inhibited or reduced, found features can be attributed to the control sample 102A and the treated sample 1 104A (labeled A). For example, if there is a difference in the expression level of the treated sample 1 104A (labeled) as compared to the control sample 102A, the difference can be attributed to the treatment condition and not necessarily to the equipment dependent variations.

A number of isotopic labeling techniques, such as SILAC, add label dependent biases, which inject falsities into experiments. Various embodiments of the present invention inhibit or reduce label dependent biases by supporting label reversal experiment protocol. For example, the control sample 102A can be labeled (labeled A) by the selected number of atomic mass units, such as six daltons, used previously to label the treated sample 1 104A. The treated sample 1 104A, on the other hand, is not labeled. The labeled control sample is now referenced as the control sample 102B and the non-labeled treated sample is now referenced as the treated sample 1 104B. The control sample 102B (labeled A) and the treated sample 1 104B can be prepared together with the control sample 102A and the treated sample 1 104A (labeled A) as the prepared sample 106 to be submitted as a single run to the system 100. By allowing both the control samples 102A, 102B (labeled A) and the treated samples 1 104A (labeled A), 104B to come into the system 100 as one prepared sample 106, the label-reversal experimental protocol is executed and label biases are inhibited or reduced.

The system 100 can also accommodate additional experiments that may be collected together with control samples 102A, 102B (labeled A) and the treated samples 1 104A (labeled A), 104B to come into the system 100 as one prepared sample 106. For example, in another experiment with using the same control sample, a control sample 102C is provided, which is identical to the control sample 102A. A treated sample 2 104C is a sample in which an instance of the control sample 102C has undergone another treatment condition different from the treatment condition to which the treated sample 1 104A (labeled A) was subjected. The treated sample 2 104C is labeled using similar isotopic labeling technique but using a different number of atomic mass units, such as 12 daltons (labeled B).

To inhibit or reduce label dependent biases, the control sample 102C and the treated sample 1 104C (labeled B) may also be subjected to a label reversal experiment protocol. For example, the control sample 102C can be labeled (labeled B) by the selected number of atomic mass units, such as 12 daltons, used previously to label the treated sample 1 104C. The treated sample 1 104C, on the other hand, is not labeled. The labeled control sample is now referenced as the control sample 102D and the non-labeled treated sample is now referenced as the treated sample 1 104D. The control sample 102D (labeled B) and the treated sample 1 104D can be prepared together with the control samples 102A-102C and the treated sample 1 104A-102C as the prepared sample 106 to be submitted as a single run to the system 100. By allowing both the control samples 102A-102D and the treated samples 1 104A-104D to come into the system 100 as one prepared sample 106, the label-reversal experimental protocol is executed and label biases are inhibited or reduced.

The prepared sample 106 is submitted to LC/MS instruments 108110. LC/MS instruments 108110 allow biological features, such as peptides, to be separated in two dimensions (retention time and mass/charge). For a given retention time, a one-dimensional continuum can be obtained in the interested mass/charge range. Biological features are shown as isotope peaks in the continuum. The peak intensity is assumed to be proportional to the relative abundance of non-radioactive, stable isotopes, which are associated with biological features of interest. Eventually, the sequentially collected one-dimensional mass-spectrometer continua form a two-dimensional data set, with retention time being referenced as the x axis and mass/charge being referenced as the y axis.

An image processing pipeline 112 produces a feature list from the two-dimensional data set obtained from the LC/MS instruments 108110, which includes feature characteristics and expression profiles. The image processing pipeline 112 facilitates feature extraction so that features that are associated with other features by some relationships are paired for further scientific research. Some of the components (not shown) of the image processing pipeline 112 include a composite image producer, which performs image preprocessing (data interpolation, image alignment, image noise filtering, background correction, and forming a composite image); and a composite image processor, which performs image feature extraction (peaks, isotope groups, and charge groups) and computes feature characteristics. Outputs of the image processing pipeline 112 include a list of features and their characteristics.

The list of features and their characteristics are provided to a paired feature processor 118. Using isotopic labeling, the paired feature processor 118 finds whether one member of a pair of features is related to the other member of the pair of features by the number of atomic mass units. (Of course, if other types of relationships are used, the relation may be found, not in the number of atomic mass units, but by other indicators.) In other words, for a given retention time, the pair of features should be found to be separated primarily by the number of atomic mass units and not necessarily in time. Given that the y-axis of the composite image references mass/charge, the pair of features can be found vertically along the y-axis for a given retention time. For example, if a given isotope peak represents the expression of a control sample, such as the control sample 102A, one would expect to find another isotope peak, which represents the expression of the treated sample 1 104A (labeled A), separated by the number of atomic mass units, such as six daltons. In the end, the paired feature processor 118 collects pairs of features, performs characteristic calculations, such as determining ratios of intensities, for further differential or non-differential analyses. For example, the pairs of features and their characteristics can help to illuminate whether protein expressions under different drug dosages occur for different experiments of different treatment conditions 102A-102D,104A-104D.

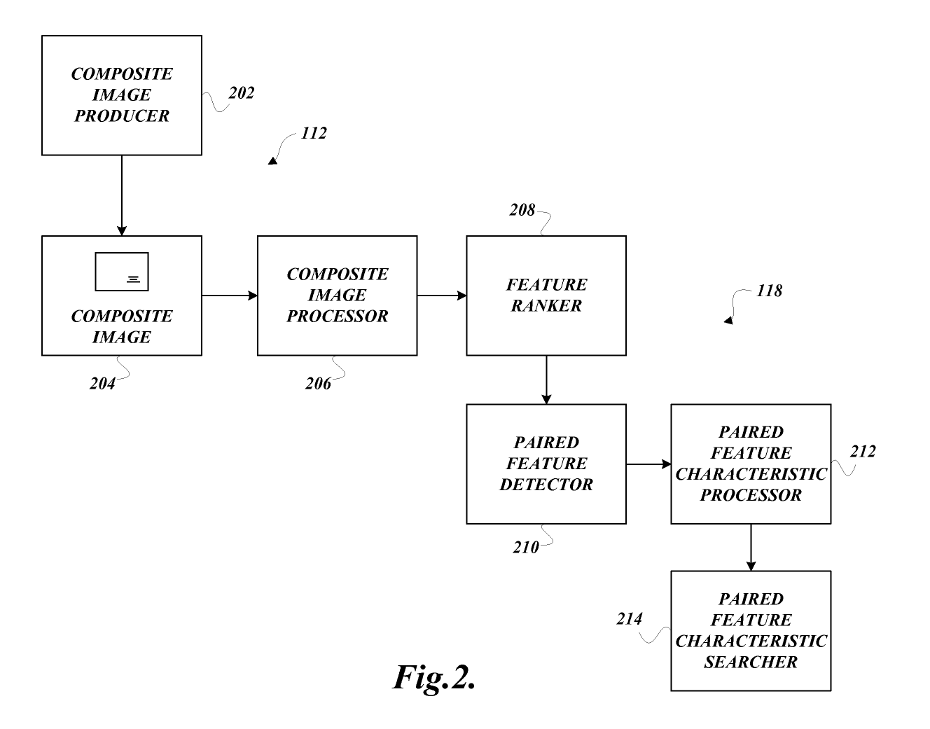

FIG. 2 shows that the image processing pipeline 112 is comprised of a composite image producer 202. The composite image producer 202 produces a composite image 204. The art has failed to recognize that merging images together into a composite image reduces noise and retains features that are weakly expressed but may be biologically important. As previously discussed, on this composite image are regions of interest that may represent features from the control samples 102A-102D, some of which are reverse-labeled (labeled A, B), and features from the treated samples 1, 2 104A-104D, some of which are labeled (labeled A, B). A composite image processor 206 processes the composite image 204 to find a list of features, such as isotope peaks, isotope groups, and charge groups. The composite image processor 206 also calculates characteristics and profiles of these features.

Previously, the art has attempted to identify all the features by determining the sequences of the features prior to finding paired features. The art has failed to recognize that the step of identifying features need not occur prior to finding paired features of interest. Sometimes it is not possible to identify those features which have a low level of expression or for which the treatment condition inhibits expression. Additionally, there may be thousands of features, and it is inefficient to identify all of them. For those features that are not a member of a pair and therefore may not have a relationship of biological significance, they need not be identified. Attempts to identify all features before pairing may slow scientific discovery.

The paired feature processor 118 is shown in greater details in FIG. 2. The paired feature processor 118 comprises a feature ranker 208, which takes the list of features produced by the composite image processor 206 and ranks the list of features. The ranking places the features in an order so that those features with characteristics of the strongest signal have priority processing. For example, the ranking may be in a descending order where features with the greatest peak intensities and/or the greatest mass/charge be listed first so that they can be processed first. In this way, various embodiments of the present invention focus initial resources to those features that are likely to point to pairs of features of interest and avoid noisy features that may lead the analysis astray.

A paired feature detector 210 receives the ranked list of features and finds paired features of interest. As previously discussed, each pair may be composed of a feature originating from a control sample 102A-102D and another feature originating from a treated sample 104A-104D. After pairs of features of interest are found, for those features that lack identifying information, such as protein sequences, targeted identification can proceed. Tandem mass spectrometers or other identifying instruments can be set to trigger upon certain features to cause a breakdown so as to obtain nucleic acid sequences or amino acid sequences for those features. Again, as previously discussed, for biological reasons, sometimes features that are biologically significant fail to show up in a run through the system 100. The use of the composite image to merge all runs together so that, even if the features fail to show up in a forward-labeled run but succeed to show up in a reverse-labeled run, these features may appear in the composite image allowing pairs of features of interest that are associated by some relationships to be found. It does not matter to various embodiments of the invention where the features show up as long as biologically significant features are captured for subsequent analysis.

The feature ranker 208 provides to the paired feature detector 210 the strongest features to the weakest features in a list. The paired feature detector 210 starts with the strongest features and parses through the list of features to determine corresponding features that are candidates for pairing because of a relationship, such as the number of atomic mass units (a relationship by weight). For example, if the number of atomic mass units is six daltons, candidate features for pairing should appear about six daltons, within a user definable tolerance, away from the strongest features for a given retention time, also within another user definable tolerance. In one embodiment, the retention time tolerance defaults to ten seconds. The user can adjust the retention time tolerance as well as the mass/charge tolerance to accommodate equipment variations.

After finding a pair of features of interest, the paired feature detector 210 removes the pair from the ranked list of features. The paired feature detector 210 then focuses on the next strongest feature in the ranked list of features and attempts to find another feature that corresponds to the strongest feature to pair them up. It is possible that the paired feature detector 210 may find a number of features that are candidates for pairing with the strongest feature. When this occurs, the paired feature detector 210 selects a candidate feature from all other candidate features that has the largest mass and the closest retention time with respect to the strongest feature in the ranked list of features. To limit computing resources that the paired feature detector 210 may use to find candidate features, the retention time tolerance defines the extent within which the paired feature detector 210 may venture to find candidate features. Similarly, a mass/charge tolerance is used to define the extent within which the paired feature detector 210 may find candidate features. In one embodiment, the default tolerance in the mass/charge direction is 0.1 part per million, and is dependent on the equipment and its operating mode.

One type of feature received by the feature ranker 208 is isotope group. There can be multiple isotope groups. One isotope group may have a number of isotope peaks, and another isotope group may have a different number of isotope peaks. There may be a large number of isotope groups. The paired feature detector 210 limits the search for pairs of features of interest by a user selectable threshold, which defaults to four. In other words, after looking at the fourth isotope group for isotope peaks that may be candidates for pairing, the paired feature detector 210 will not venture beyond to other isotope groups to find additional candidates.

The paired feature detector 210 determines a common number of isotope peaks between two isotope groups, focuses on the common number, and disregards extra isotope peaks that are not part of the common number of isotope peaks. For example, a first isotope group has three isotope peaks beginning with those isotope peaks with the lowest mass/charge; the paired feature detector 210 may have found a paired feature in a second isotope group but this second isotope group has five isotope peaks. In one embodiment, to create a common number of isotope peaks, the paired feature detector 210 may choose to use the three lowest mass/charge isotope peaks of the first isotope group and the three lowest mass/charge isotope peaks of the second isotope group while disregarding the highest mass/charge isotope peaks of the second isotope group. In another embodiment, the common number of isotope peaks can be chosen from those isotope peaks that have the greatest intensities. For example, the paired feature detector 210 may choose to use the three isotope peaks with the greatest intensities in both the first and second isotope groups.

Paired features of interest found by the paired feature detector 210 are forwarded to a paired feature characteristic processor 212. One processed characteristic includes ratios of intensities. The paired feature characteristic processor 212 takes the intensities of isotope peaks of one isotope group as members of a pair, which represent a treated sample, and sums the intensities into a dividend. The paired feature characteristic processor 212 then takes the intensities of isotope peaks of another isotope group as members of the pair, which represent a control sample, and sums the intensities into a divisor. A ratio is created from the dividend and the divisor. The paired feature characteristic processor 212 creates sets of ratios. From these ratios, the paired feature characteristic processor 212 generates profiling parameters for allowing expression information to be searched. One profiling parameter is to take the common logarithm of a ratio after which the error of the common logarithm is calculated to obtain p-values for each pair of features.

P-values are used for differential detection. A user can use a paired feature characteristic searcher 214 to set a differential threshold. The paired feature characteristic searcher 214 gathers those pairs with p-values that are less than the differential threshold and present those pairs to the user for further analysis. For example, in looking closer at a pair of features that is found by the paired feature characteristic searcher 214, the user may determine that a member of the pair may lack identifying information. The user may set a triggering mechanism at a particular retention time in a tandem mass spectrometry process to cause instruments to target the member of the pair to determine its nucleic acid or amino acid sequence. This avoids the need to identify all features and instead those features that have an experimental or biological relationship are brought to the fore as a focus for further discovery.

As an aside, the paired feature characteristic processor 212 may perform normalization. If a ratio of intensities is less than a normalization level, the ratio may not add knowledge and the ratio can be eliminated. One normalization technique includes summing all isotope peaks of a control sample and dividing by the number of isotope peaks to obtain an average of the control sample. Similarly, an average of the treated sample is obtained by summing all isotope peaks of a treated sample and dividing by the number of isotope peaks. If the averages of the control sample and the treated sample are not similar, a scaling process is executed to produce a normalization level to get rid of ratios that are not significant.

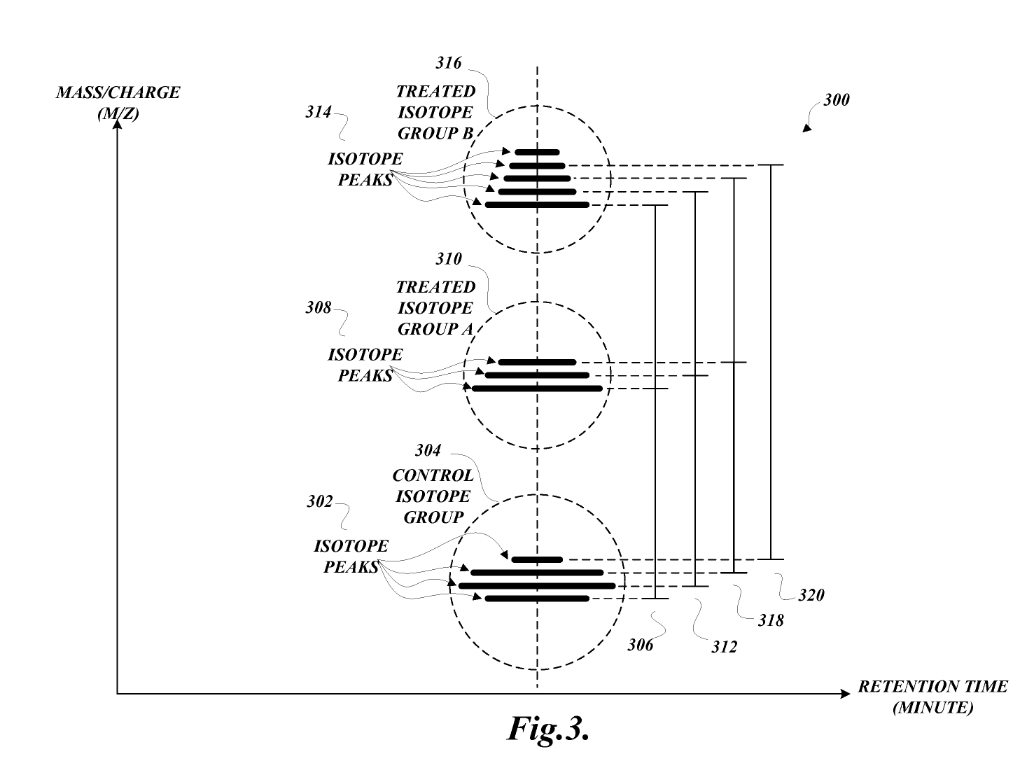

A graph 300 visually explains a composite image that includes features of interest representing common samples and treated samples. See FIG. 3. The graph 300 includes a y-axis, which is a reference for a mass/charge dimension, and an x-axis, which is a reference for a retention time dimension. At a particular retention time, three isotope group features appear. One of the three isotope groups includes a control isotope group 304, which represents a control sample. The control isotope group 304 includes four isotope peaks 302. The four isotope peaks 302 may be members of pairs that relate a control sample to a treated sample.

Another of the three isotope groups includes a treated isotope group A 310 that has three isotope peaks 308. The treated isotope group A 310 appears along a similar retention time as the control isotope group 304 and thus, the three isotope peaks 308 may be candidates for pairing with the isotope peaks 302 of the control isotope group 304. The treated isotope group A 310 may represent a treated sample that has been labeled by a number of atomic mass units, which separate the treated isotope group A 310 from the control isotope group 304 by the amount of atomic mass units used in the isotopic labeling, such as six daltons. A common number of isotope peaks may be established by the paired feature processor 118 given the differences in the number of isotope peaks 302 and 308. For example, there are three isotope peaks in the isotope peaks 308 whereas there are four isotope peaks in the isotope peaks 302. In this instance, the common number of isotope peaks may be designated as three given that the treated isotope group A 310 has three isotope peaks 308.

If another experiment was part of the same prepared sample submitted to the LC/MS instruments 108110, a representation of another treated sample may appear on the graph 300, such as a treated isotope group B 316, which has five isotope peaks 314. If the same common sample was used, some of the five isotope peaks 314 of the treated isotope group B 316 may be paired with the isotope peaks 302 of the control isotope group 304. A common number of isotope peaks is determined, which in this case is four. If a scheme for establishing common isotope peaks is based on the lowest isotope peaks of the isotope groups 304, 310, and 316, a line 306 has three ticks. The bottom tick of the line 306 indicates that the lowest isotope peak 302 can be paired with the lowest isotope peak 308 referenced by the middle tick, and furthermore, the lowest isotope peak 302 can be paired with the lowest isotope peak 314 as referenced by the top tick of the line 306. The remaining lines 312, 318, and 320 shows other pairings.

The graph 300 shows that the focus on various embodiments of the present invention is to find pairs of features that are associated with each other according to some relationship. The graph 300 shows isotope groups appearing at a similar retention time and these isotope groups are separated by a certain mass/charge, which may define the relationship. These relationships define constraints by which the paired feature processor 118 can find pairs of features of interest. In some of the above examples, an isotopic label was added to a treated sample. In other examples (not shown), instead of using isotopic labels, the paired feature processor 118 can find relationships that are based on other constraints, such as the presence of a particular molecule, and so on. In yet other examples (not shown), the paired feature processor 118 can find relationships that are based on metabolites, such as the present of an acquired atom or the loss of an atom, and so on.

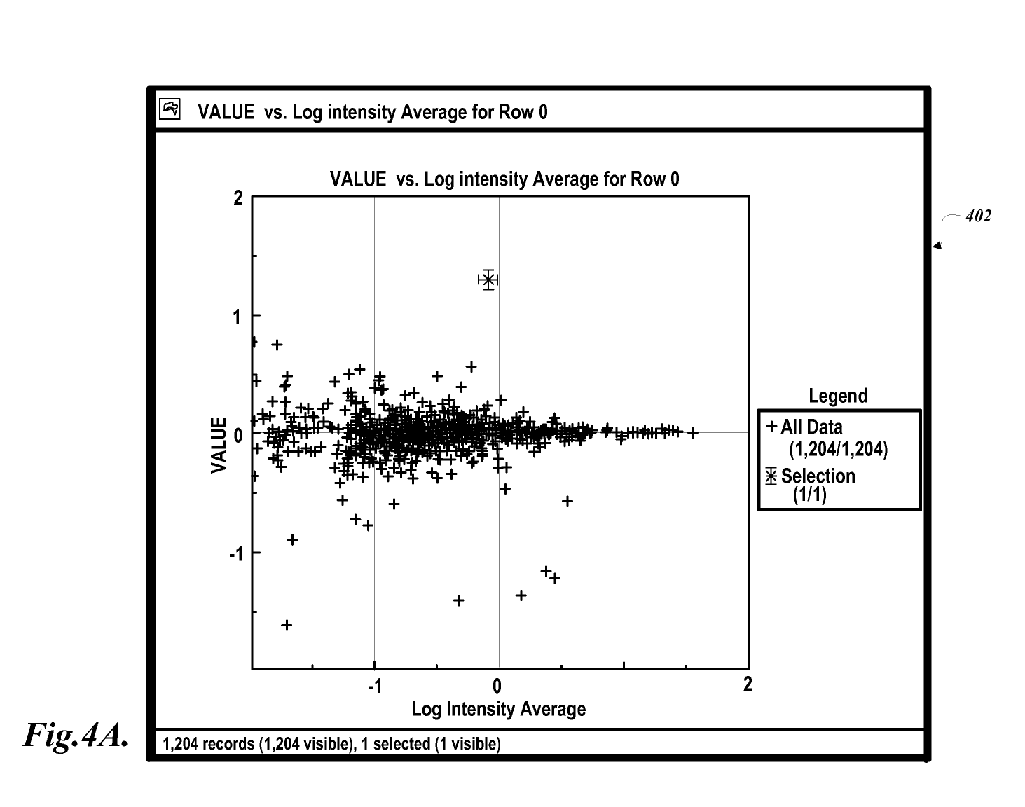

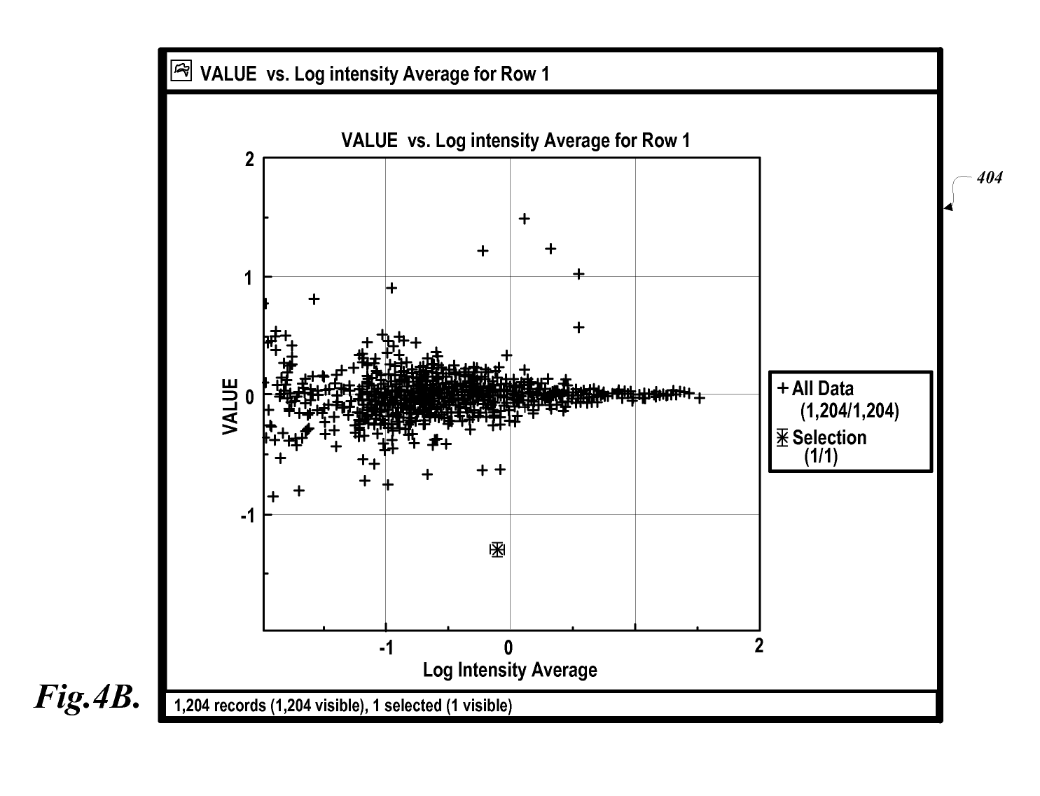

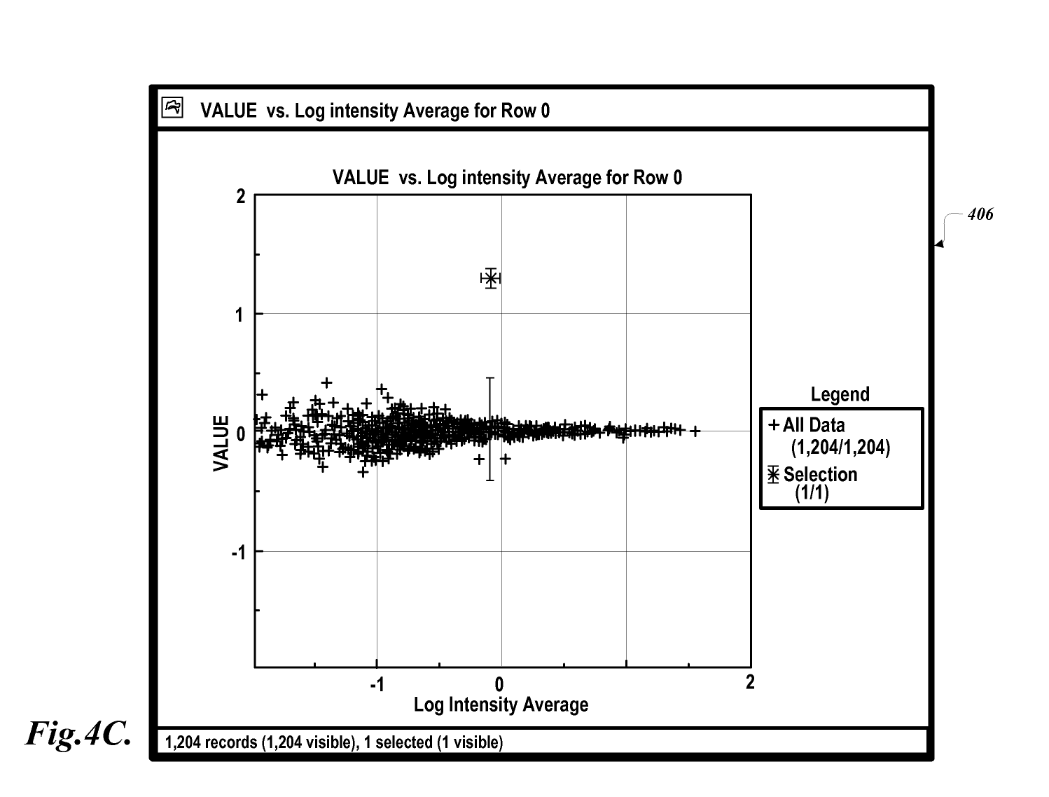

Some experiments introduce bias, which is not desired. For example, in attaching an isotopic label to a treated sample, a bias may be introduced. Some peptides exhibit consistent label-dependent ratio biases. These biases may appear in up regulation, down regulation, or both. The resultant expression of the treated sample may also contain the same bias. The art has failed to recognize that this bias should be removed to enhance experimental results. Graphs 402-406 as illustrated in FIGS. 4A-4C show a removal of biases after a reverse-label experimental protocol is implemented. In all graphs 402-406, the y-axis references the natural logarithm of the ratios and the x-axis references the natural logarithm of the scaled intensities of the paired features. The graph 402 (which displays features that are forward-labeled) and the graph 404 (which displays features that are reverse-labeled) show biases away from the clusters. After executing a reverse-label experiment protocol, these biases disappear as shown by the graph 406.

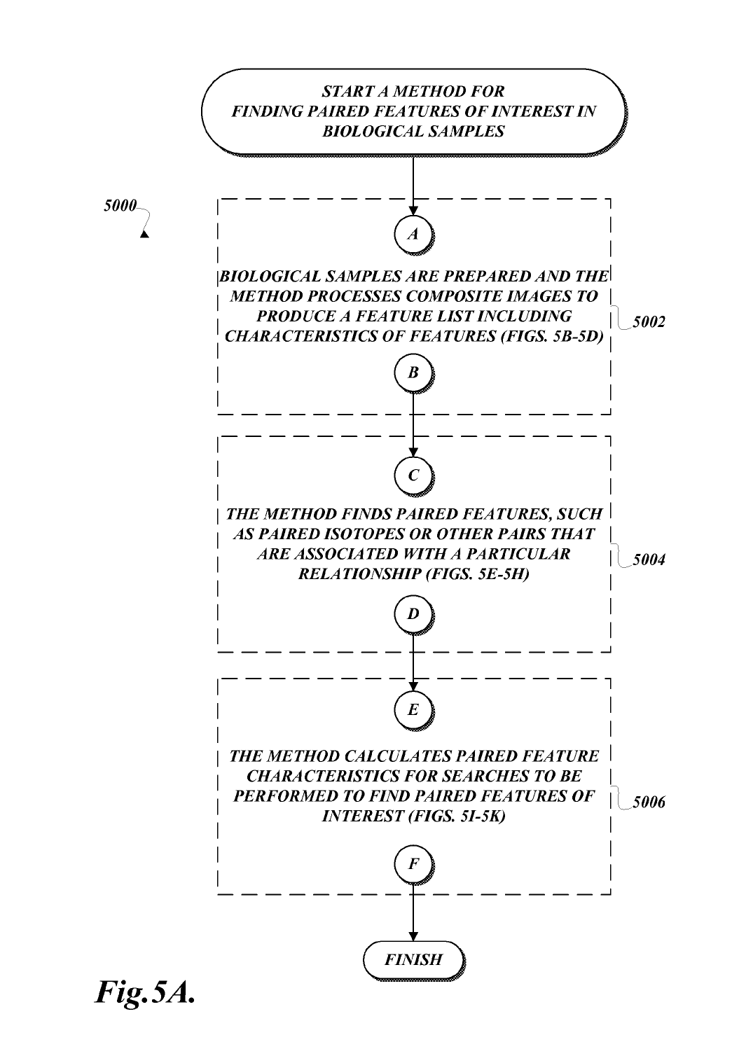

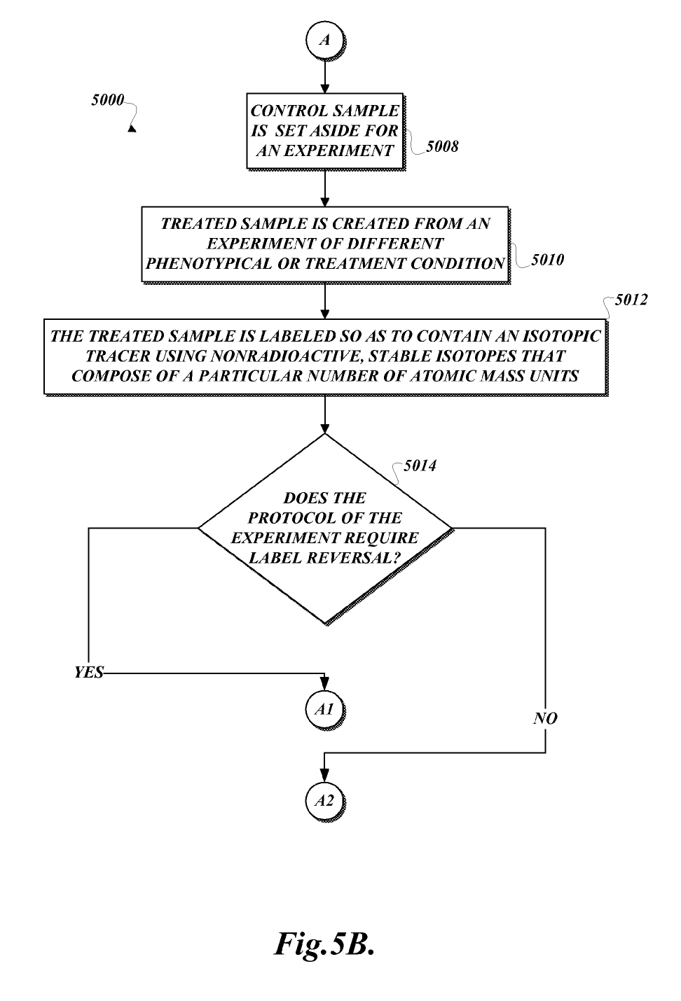

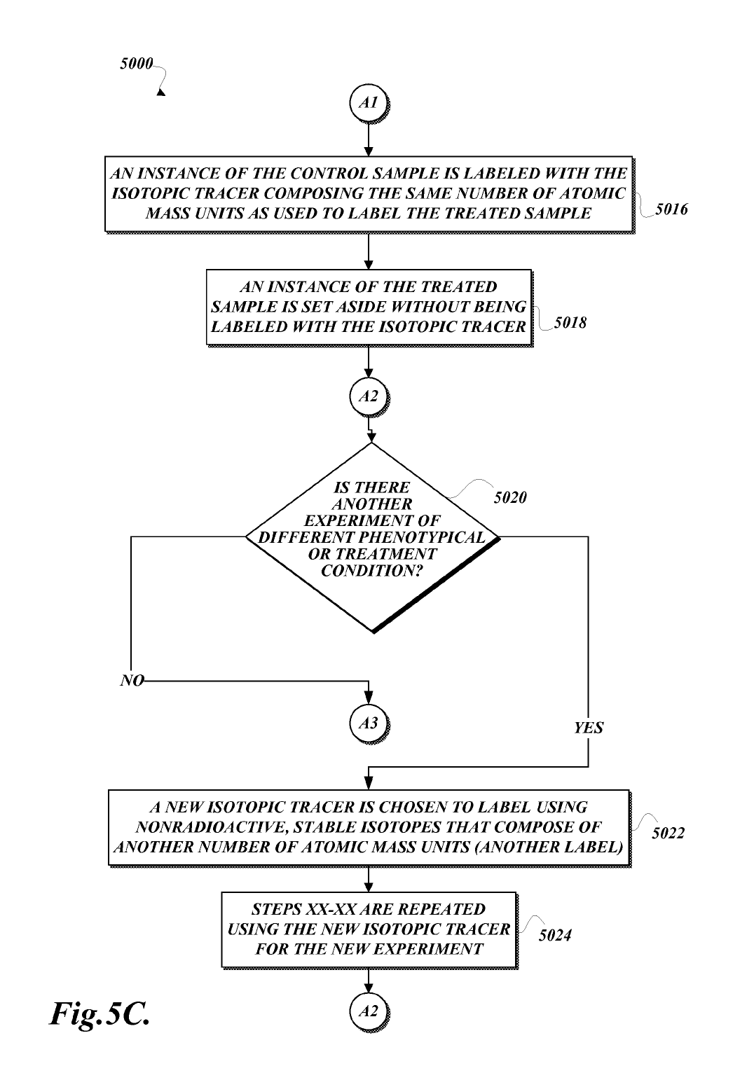

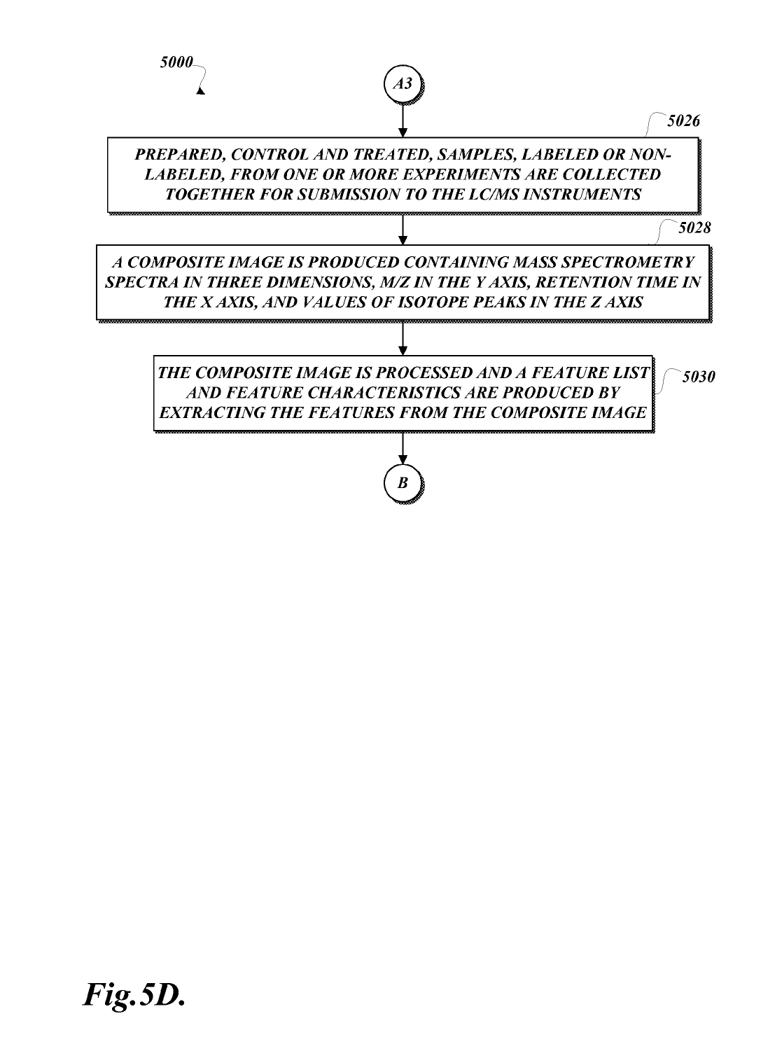

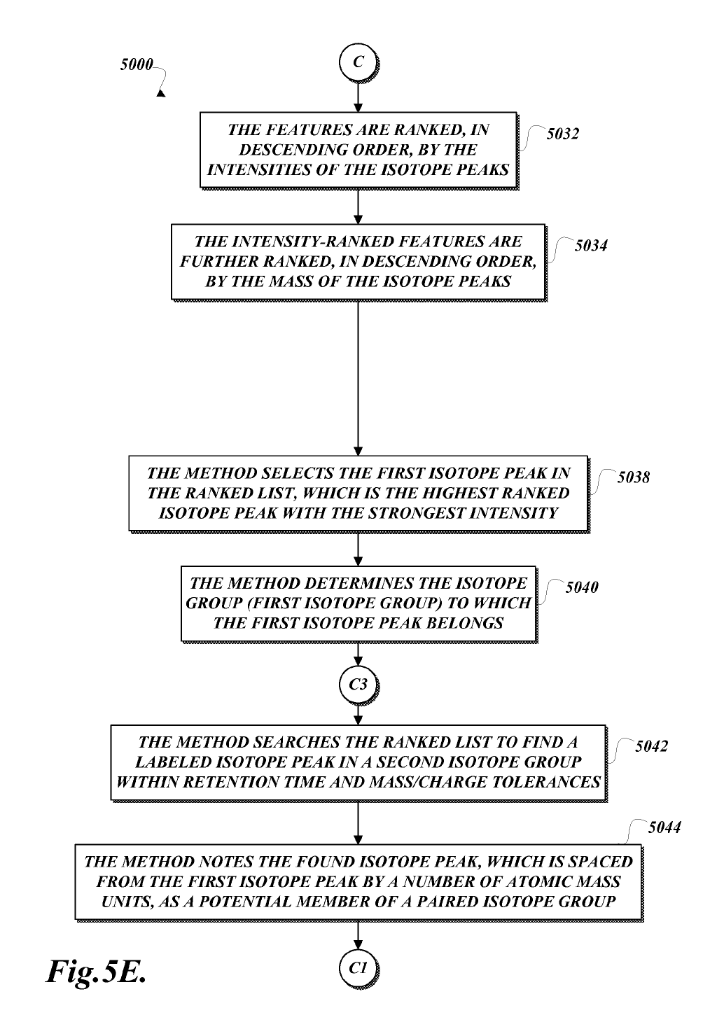

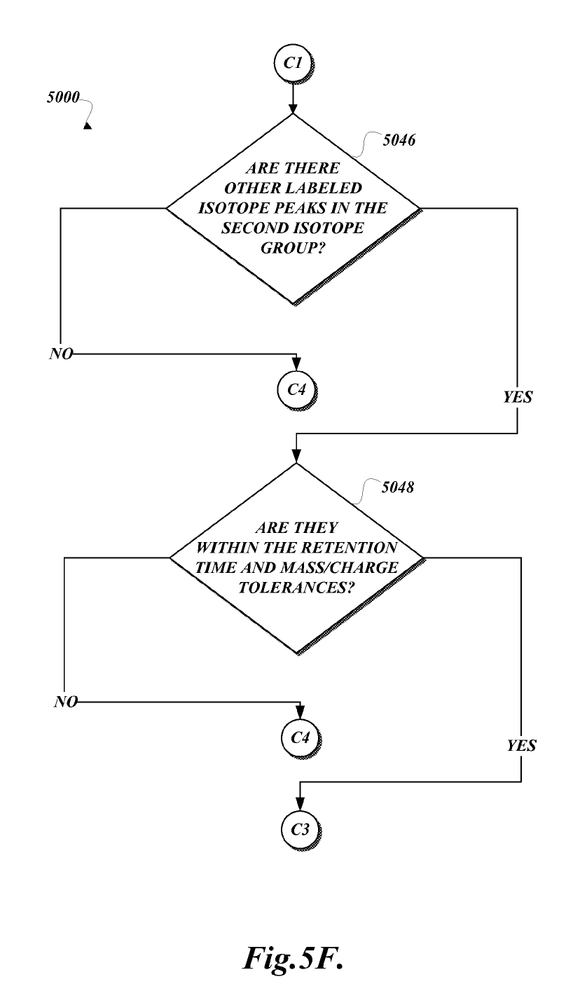

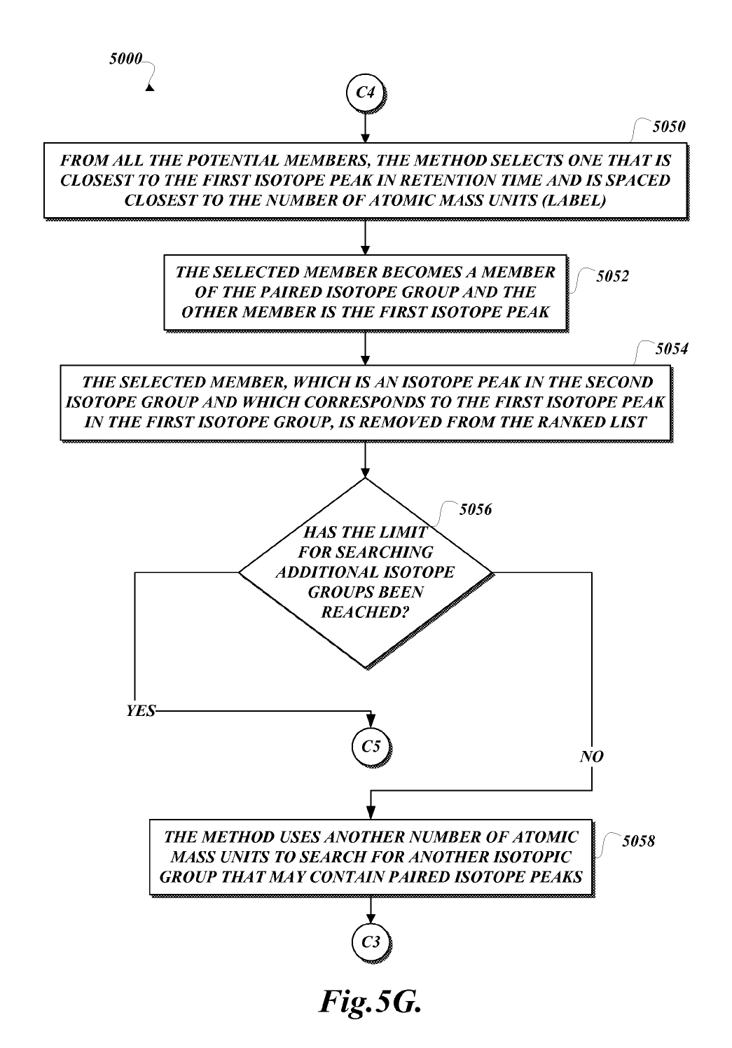

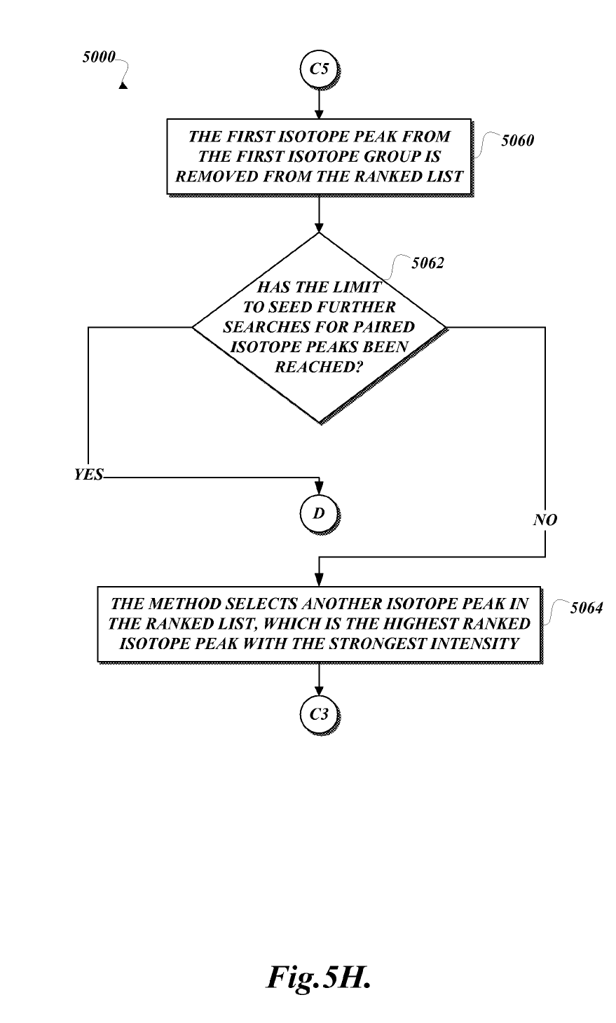

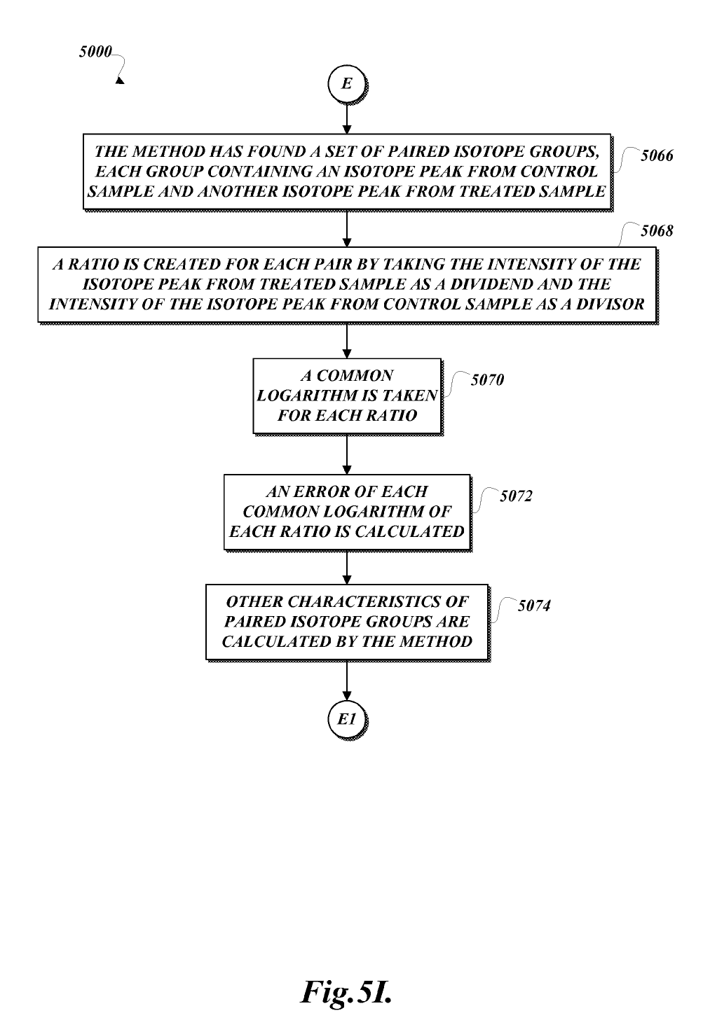

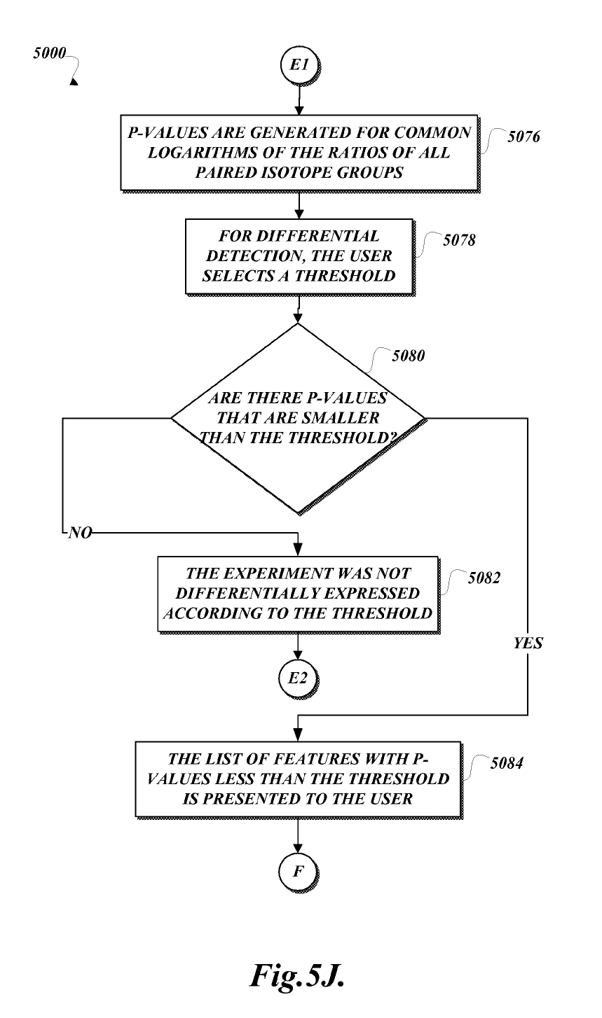

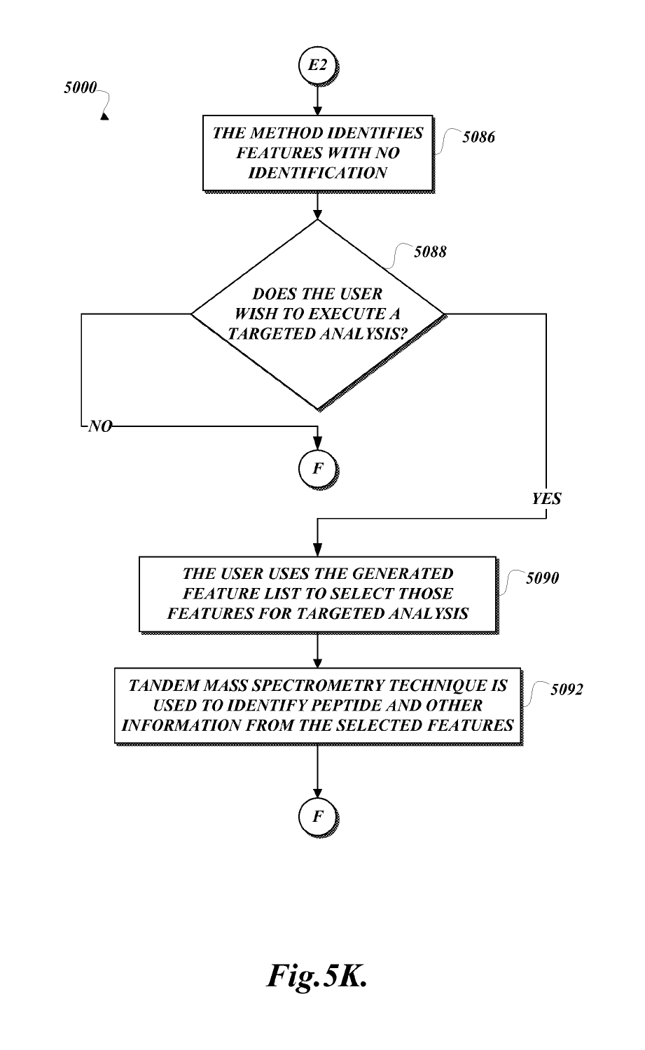

FIGS. 5A-5K illustrate a method 5000 for finding paired features of interest in biological samples. From a start block, the method 5000 proceeds to a set of method steps 5002, defined between a continuation terminal (“Terminal A”) and an exit terminal (“Terminal B”). The set of method steps 5002 describes the production of a prepared sample and its processing to produce a composite image for feature extraction and calculation of feature characteristics.

From Terminal A (FIG. 5B), the method 5000 proceeds to block 5008 where a control sample is set aside for an experiment. A treated sample is created from an experiment of a different phenotypical or treatment condition. See block 5010. The treated sample is labeled so as to contain an isotopic tracer using non-radioactive, stable isotopes that composed of a particular number of atomic mass units, such as six daltons. See block 5012. The method then continues to decision block 5014 where a test is performed to determine whether the protocol of the experiment requires label reversal. If the answer to the test at decision block 5014 is YES, the method 5000 proceeds to another continuation terminal (“Terminal A1”). If the answer to the test at decision block is NO, the method 5000 proceeds to another continuation terminal (“Terminal A2”).

From Terminal A1 (FIG. 5C), an instance of the control sample is labeled with the isotopic tracer composing the same number of atomic mass units as was used to label the treated sample. See block 5016. An instance of the treated sample is set aside without being labeled with the isotopic tracer. See block 5018. Next, at decision block 5020, a test is performed to determine whether there is another experiment of a different phenotypical or treatment condition. If the answer to the test at decision block 5020 is NO, the method continues to another continuation terminal (“Terminal A3”). If the answer to the test at decision block 5020 is YES, the method continues to block 5022 where a new isotopic tracer is chosen as a label using non-radioactive, stable isotopes composed of another number of atomic mass units (another label), such as 12 daltons. Steps 5008-5018 are repeated using the new isotopic tracer for the new experiment. See block 5024. The method then continues to Terminal A2.

From Terminal A3 (FIG. 5D), the method 5000 proceeds to block 5026 where prepared control and treated samples, labeled or non-labeled, from one or more experiments are collected together as a prepared sample for submission to the LC/MS instruments. A composite image is produced containing mass spectrometry spectra in three dimensions: mass/charge in the y-axis, retention time in the x-axis, and values of isotope peaks in the z-axis. The method then continues to the exit terminal B.

From Terminal B (FIG. 5A), the method 5000 proceeds to a set of method steps 5004, defined between a continuation terminal (“Terminal C”) and an exit terminal (“Terminal D”). The set of method steps 5004 finds paired features, such as paired isotope peaks or other pairs that are associated by a particular relationship.

From Terminal C (FIG. 5E), the method 5000 proceeds to block 5032 where the features are ranked, in descending order, by the intensities of the isotope peaks. The intensity-ranked features are further ranked, in descending order, by the mass of the isotope peaks. See block 5034. The method 5000 then selects the first isotope peak in the ranked list, which is the highest ranked isotope peak with the strongest intensity. See block 5038. The method determines the isotope group (first isotope group) to which the first isotope peak belongs. See block 5040. The method continues to another continuation terminal (“Terminal C3”). The method searches the ranked list to find a labeled isotope peak in a second isotope group within retention time and mass/charge tolerances. See block 5042. The method notes the found isotope peak, which is spaced from the first isotope peak by a number of atomic mass units, such as six daltons, as a potential candidate or member of a paired isotope group. See block 5044. The method continues to another continuation terminal (“Terminal C1”).

From Terminal C1 (FIG. 5F), the method 5000 proceeds to decision block 5046 where a test is performed to determine whether there are other labeled isotope peaks in the second isotope group. If the answer to the test at decision block 5046 is NO, the method 5000 proceeds to another continuation terminal (“Terminal C4”). If the answer to the test at decision block 5046 is YES, the method 5000 proceeds to another decision block where another test is performed to determine whether the other labeled isotope peaks are within the retention time and mass/charge tolerances. If the answer to the test at decision block 5048 is NO, the method continues to Terminal C4. If the answer to the test at decision block 5048 is YES, the method continues to Terminal C3.

From Terminal C4 (FIG. 5G), the method 5000 proceeds to block 5050 where from all the candidates or potential members, the method 5000 selects one that is closest to the first isotope peak in retention time and is spaced closest to the number of atomic mass units (label). The selected member becomes a member of the paired isotope group and the other member is the first isotope peak. See block 5052. The selected member, which is an isotope peak in the second isotope group and which corresponds to the first isotope peak in the first isotope group, is removed from the ranked list. See block 5054. A test is performed at decision block 5056 to determine whether the limit for searching additional isotope groups has been reached. If the answer to the test at decision block 5056 is YES, the method 5000 continues to another continuation terminal (“Terminal C5”). If the answer to the test at decision block 5056 is NO, the method 5000 continues to block 5058 where the method uses another number of atomic mass units to search for another isotopic group that may contain paired isotope peaks. The method then proceeds to Terminal C3 and skips back to block 5042 where the above processing steps are repeated.

From Terminal C5 (FIG. 5H), the method 5000 proceeds to block 5060 where the first isotope peak from the first isotope group is removed from the ranked list. A test is performed at decision block 5062 to determine whether the limit to seed further searches for paired isotope peaks has been reached. If the answer to the test at decision block 5062 is YES, the method proceeds to exit terminal D. If the answer to the test at decision block 5062 is NO, the method proceeds to block 5064 where the method 5000 selects another isotope peak in the ranked list, which is the highest ranked isotope peak with the strongest intensity. The method then continues to Terminal C3 and skips back to block 5042 where the above processing steps are repeated.

From exit terminal D (FIG. 5A), the method 5000 proceeds to a set of method steps 5006, defined between a continuation terminal (“Terminal E”) and an exit terminal (“Terminal F”). The set of method steps describes the calculation of paired feature characteristics for searches to be performed to find paired features of interest.

From Terminal E (FIG. 5I), the method 5000 proceeds to block 5066 where the method has found a set of paired isotope groups, each group containing an isotope peak from a control sample and another isotope peak from a treated sample. A sum of intensities of all members of a pair that belong to one isotope group is calculated. For example, if there are three pairs, each pair including a member that originates from a control sample, the peak intensities of the three members that originate from the control sample are summed. The peak intensities of the remaining three members that originate from the treated sample are summed. A ratio is created for each pair by taking the sum of intensities of the isotope peaks from a treated sample as a dividend and the sum of intensities of the isotope peaks from a control sample as a divisor. See block 5068. A common logarithm is taken for each ratio. See block 5070. The error of each common logarithm of each ratio is calculated. See block 5072. Other characteristics of paired isotope groups are calculated by the method. See block 5074. The method proceeds to another continuation terminal (“Terminal E1”).

From Terminal E1 (FIG. 5J), the method 5000 proceeds to block 5076 where p-values are generated for the common logarithms of the ratios of all paired isotope groups. For differential detection, a user specify a differential threshold. See block 5078. A test is performed to determine whether there are p-values that are smaller than the threshold. See decision block 5080. If the answer to the test at decision block 5080 is NO, the method 5000 proceeds to block 5082 where the experiment was not differentially expressed according to the threshold. The method continues to another continuation terminal (“Terminal E2”). If the answer to the test at decision block 5080 is YES, the method 5000 proceeds to block 5084 where the list of features with p-values less than the threshold is presented to the user. The method continues to exit terminal F and terminates execution.

From Terminal E2 (FIG. 5K), the method 5000 proceeds to block 5086 where the method 5000 identifies features with no identification. A test is performed at decision block 5088 to determine whether the user wishes to execute a targeted analysis. If the answer to the test at decision block 5088 is NO, the method 5000 proceeds to exit terminal F and terminates execution. If the answer to the test at decision block 5088 is YES, the method 5000 proceeds to block 5090 where the user uses the generated feature list to select those features for targeted analysis. Tandem mass spectrometry technique is used to identify peptide sequences and other information from the selected features. See block 5092. The method continues to exit terminal F and terminates execution.

While illustrative embodiments have been illustrated and described, it will be appreciated that various changes can be made therein without departing from the spirit and scope of the invention.

1. A method for finding paired features in biological samples, comprising:
without having to identify a nucleic acid sequence of features, forming a composite image from an experiment in which a control sample and a treated sample, which has a tracing relationship with the control sample, are brought together as a prepared sample; and
finding pairs of features of interest from the composite image, a member of a pair of features of interest being associated with another member of the pair according to the tracing relationship, which describes a constraint to find both members of the pair on the composite image.

2. The method of claim 1, wherein the tracing relationship is created by isotopic labeling an instance of the treated sample with a number of atomic mass units of non-radioactive, stable isotopes while an instance of the control sample does not undergo isotopic labeling.

3. The method of claim 2, wherein the tracing relationship is created by reverse-labeling in which an instance of the control sample undergoes isotopic labeling with the same number of atomic mass units used previously for isotopic labeling the treated sample while an instance of the treated sample does not undergo isotopic labeling.

4. The method of claim 1, wherein the tracing relationship is created by tracing an addition or a loss of one or more molecules in a metabolic experiment.

5. The method of claim 1, wherein finding pairs of features of interest includes finding isotope groups, each isotope group representing either a control sample or a treated sample, and establishing a common number of isotope peaks to search for pairs of features of interest.

6. The method of claim 1, further comprising calculating a natural logarithm of a ratio, the ratio comprising a dividend and a divisor, the dividend being a sum of intensities of isotope peaks of an isotope group that represents the treated sample, the divisor being a sum of intensities of isotope peaks of another isotope group that represents the control sample.

7. The method of claim 6, further comprising calculating an error of the natural logarithm of a ratio to produce a p-value for the ratio, the p-value being indicative of a differential expression level of the treated sample.

8. A storable computer-readable medium having stored thereon computer-executable instructions for implementing a method for finding paired features in biological samples, comprising:
without having to identify a nucleic acid sequence of features, forming a composite image from an experiment in which a control sample and a treated sample, which has a tracing relationship with the control sample, are brought together as a prepared sample; and
finding pairs of features of interest from the composite image, a member of a pair of features of interest being associated with another member of the pair according to the tracing relationship, which describes a constraint to find both members of the pair on the composite image.

9. The computer-readable medium of claim 8, wherein the tracing relationship is created by isotopic labeling an instance of the treated sample with a number of atomic mass units of non-radioactive, stable isotopes while an instance of the control sample does not undergo isotopic labeling.

10. The computer-readable medium of claim 9, wherein the tracing relationship is created by reverse-labeling in which an instance of the control sample undergoes isotopic labeling with the same number of atomic mass units used previously for isotopic labeling the treated sample while an instance of the treated sample does not undergo isotopic labeling.

11. The computer-readable medium of claim 8, wherein the tracing relationship is created by tracing an addition or a loss of one or more molecules in a metabolic experiment.

12. The computer-readable medium of claim 8, wherein finding pairs of features of interest includes finding isotope groups, each isotope group representing either a control sample or a treated sample, and establishing a common number of isotope peaks to search for pairs of features of interest.

13. The computer-readable medium of claim 8, further comprising calculating a natural logarithm of a ratio, the ratio comprising a dividend and a divisor, the dividend being a sum of intensities of isotope peaks of an isotope group that represents the treated sample, the divisor being a sum of intensities of isotope peaks of another isotope group that represents the control sample.

14. The computer-readable medium of claim 13, further comprising calculating an error of the natural logarithm of a ratio to produce a p-value for the ratio, the p-value being indicative of a differential expression level of the treated sample.

15. A system for finding paired features of interest, comprising:
a collection of chromatography and mass spectrometry instruments for receiving a prepared sample in which a control sample and a treated sample are submitted together for processing;
an image processing pipeline for creating and processing a composite image from the prepared sample on which features are extracted and characteristics are calculated; and
a paired feature processor for processing the features from the composite image to find pairs of features of interest that are associated with one another according to a relationship without having to first identify the nucleic acid sequences of the features.

16. The system of claim 15, wherein the image processing pipeline comprises a composite image producer, which performs data interpolation, image alignment, image noise filtering, background correction, and forming of the composite image.

17. The system of claim 16, wherein the image processing pipeline comprises a composite image processor, which extracts features including peaks, isotope groups, and charge groups and computes feature characteristics.

18. The system of claim 15, wherein the paired feature processor comprises a feature ranker for ranking features that have the strongest signal first for priority processing.

19. The system of claim 18, wherein the paired feature processor comprises a paired feature detector, which finds pairs of features of interest according to the relationship by searching the composite image.

20. The system of claim 19, wherein the paired feature processor comprises a paired feature characteristic processor, which produces p-values from taking the errors of the natural logarithms of ratios, each ratio comprising a dividend and a divisor, the dividend being a sum of intensities of isotope peaks of an isotope group that represents the treated sample, the divisor being a sum of intensities of isotope peaks of another isotope group that represents the control sample.
